(19) United States
(12) Patent Application Publication
(10) Pub. No.: US 2007/0026712 A1
(43) Pub. Date: Feb. 1, 2007

(54) Semiconductor device and method of fabricating the same

(75) Inventors: Joo-byoung Yoon, Yongin-si (KR); Jin-sung Kim, Suwon-si (KR); Chang-hyuk Ok, Yongin-si (KR); Kyung-woo Lee, Suwon-si (KR); Yeong-cheol Lee, Seoul (KR); Sang-jun Park, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/496,438

(22) Filed: Aug. 1, 2006

(30) Foreign Application Priority Data
Aug. 1, 2005 (KR) 2005-0070321

(51) Int. Cl. H01R 3/08

(52) U.S. Cl. 439/179

(57) ABSTRACT

Example embodiments of the present invention relate to a semiconductor device and a method of fabricating the same. Other example embodiments of the present invention relate to a semiconductor device having a metal silicide layer of a substrate and a barrier metal layer constituting a line layer and a method of fabricating the same. The semiconductor device may include a bar-type contact structure (e.g., a contact surface with an active region is bar shaped) and a dot-type contact structure (e.g., the contact surface is dot shaped). The bar-type contact structure may have a larger contact area with the active region. The bar-type contact structure may retard or prevent an ohmic contact layer, which is formed by the chemical combination of a barrier metal layer and a substrate between which a semiconductor layer is interposed, from being extended outside source/drain regions or being electrically shorted to a gate electrode. A contact hole exposing the substrate in a dot shape may be formed after the semiconductor layer is formed on the active region exposed in a bar shape.

This non-provisional application claims priority under 35 U.S.C. § 119(a) to Korean Patent Application No. 2005-70321, filed on Aug. 1, 2005, in the Korean Intellectual Property Office (KIPO), the entire contents of which are herein incorporated by reference.

### BACKGROUND

1. Field

Example embodiments of the present invention relate to a semiconductor device and a method of fabricating the same. Other example embodiments of the present invention relate to a semiconductor device having a metal silicide layer of a substrate and a barrier metal layer constituting a line layer and a method of fabricating the same.

2. Description of the Related Art

With higher integration of semiconductor devices, the electrical resistance between metal lines may need to be reduced for higher operating speeds. An ohmic contact, enabling a bidirectional conduction of electrical charges, may form a lower-resistance contact between a metal line and a semiconductor substrate. A contact structure, where a contact surface between the metal line and the semiconductor substrate has a bar shape (not a dot shape), may be adopted to increase the contact area between the metal line and the semiconductor, and thus, may reduce the contact resistance therebetween. Transistors, serving as unit devices in a semiconductor device, may be designed in various sizes and may be connected to a plurality of dot-type contact holes and/or one bar-type contact holes according to the area of a source or drain region.

FIG. 1A is a diagram illustrating a conventional semiconductor device and FIG. 1B is a diagram illustrating a line I-I′ of FIG. 1A. Referring to FIGS. 1A and 1B, a semiconductor device (e.g., a DRAM device) may include a cell region and a peripheral circuit region. The peripheral circuit region may include a bar contact region where a bar-type contact is connected and a dot contact region where a dot-type contact is connected.

A device isolation layer 12 may be formed in a semiconductor substrate 10. Active regions 13c, 13b and 13d may be formed in the cell region, the bar contact region and the dot contact region, respectively. Gate patterns 20c, 20b and 20d may be formed across the top of the active regions 13c, 13b and 13d, respectively. The gate patterns may include a gate insulating layer 14, a gate electrode 16, and a capping layer 18 that are stacked on the active region and a spacer pattern 22 formed on the sidewalls thereof.

A source region 13s and a drain region 13d may be formed in the active region between the gate patterns 20c of the cell region. Contact pads 26s and 26d may be formed between the gate patterns 20c of the cell region on the source and drain regions 13s and 13d. A source/drain region 13 may be formed in the active region at both sides of peripheral circuit gate patterns 20b and 20d of the bar contact region and the dot contact region. A first interlayer insulating layer 24 and a second interlayer insulating layer 28 may be formed on the entire surface of the substrate where the gate patterns 20c, 20b and 20d and the contact pads 26s and 26d are formed. The second interlayer insulating layer 28 of the cell region may be patterned to form a bit line contact hole 30c exposing the contact pad. The first and second interlayer insulating layers 24 and 28 of the peripheral circuit region may be patterned to form a bar-type contact hole 30b and a dot-type contact hole 30d respectively in the bar contact region and the dot contact region, thereby exposing the active region. The bit line contact hole 30c, the bar-type contact hole 30b, and the dot-type contact hole 30d may be filled with a conformal barrier metal layer 32 and a conductive material 34, thereby forming a bit line in the cell region and forming line layers I1 and I2 in the peripheral circuit region. A bit line BL may pass through the second interlayer insulating layer 28 and may be connected to the drain pad 26d.

FIGS. 1C and 1D are diagrams illustrating a dot-type contact structure A2 and a bar-type contact structure A1 illustrated in FIG. 1B. Referring to FIGS. 1C and 1D, the line may be formed of a lower-resistance metal or a metal silicide 34. The conformal barrier metal layer 32 may be formed in the contact holes so that contact resistance to the substrate may be reduced by an ohmic contact. A metal silicide layer may be formed at a contact surface between the barrier metal layer and the substrate exposed through the contact hole. As illustrated in FIG. 1C, in the dot-type contact hole where the exposed area of the substrate is smaller, a thin silicide layer 36 may be formed at an interface between the barrier metal layer and the substrate. In the bar-type contact hole, where the exposed area of the substrate is larger, the contact area between the barrier metal layer and the substrate may become larger. The substrate may be undesirably silicided, for example, a silicide layer 38 (i.e., an ohmic contact layer) may deviate from the source/drain region 13. The distance L between the silicide layer 38 and a gate electrode may be reduced such that an electrical charge leaking through the substrate may electrically short the source region and/or the drain region and the gate electrode. The silicide layer 38 may be extended deeper than the source region or the drain region.

### SUMMARY

Example embodiments of the present invention relate to a semiconductor device and a method of fabricating the same. Other example embodiments of the present invention relate to a semiconductor device having a metal silicide layer of a substrate and a barrier metal layer constituting a line layer and a method of fabricating the same.

Example embodiments of the present invention provide a semiconductor device and a fabrication method thereof, which may retard or prevent a substrate from being undesirably silicided in a bar-type contact hole where the exposed area of the substrate is larger.

Example embodiments of the present invention also provide a semiconductor device and a fabrication method thereof, which may reduce resistance between a substrate and a metal line and may reduce or prevent undesirable silicidation of the substrate.

Example embodiments of the present invention provide a semiconductor device in which a semiconductor layer is interposed between a barrier metal layer and a substrate in a contact hole where an exposed area of the substrate is larger. The semiconductor device may include a first active region to which a bar-type contact pattern is. An interlayer insulating layer may be formed on the entire surface of the substrate including the first active region. A first contact hole, which penetrates the interlayer insulating layer to the active region, may be formed in the first active region. The first contact hole may be formed such that the first active region is exposed in a bar shape. A conformal barrier metal layer may be formed in the first contact hole and a conductive layer may be formed to fill the first contact hole. The semiconductor device may further include a second active region to which a dot-type contact pattern is connected. An interlayer insulating layer may be formed on the entire surface of the substrate including the second active region. A second contact hole, which penetrates the interlayer insulating layer to the active region, may be formed in the second active region. The second contact hole may be formed such that the second active region is exposed in a dot shape. A conformal barrier metal layer may be formed in the second contact hole and a conductive layer may be formed to fill the second contact hole.

Since the semiconductor layer is interposed between the barrier metal layer and the substrate under the first contact hole, a desired gap may be provided between the substrate and the barrier metal layer to retard or prevent undesirable silicidation of the substrate. The barrier metal layer in the second contact hole may directly contact the substrate. The conductive layer and the barrier metal layer, which are formed in the first or second contact hole, may form contact patterns. The contact patterns may form a bar-type contact structure or a dot-type contact structure according to the shape of the contact hole. The bar-type contact structure may have the semiconductor layer with a desired thickness interposed between the substrate and the barrier metal layer, and thus the substrate may not be undesirably silicided. The dot-type contact structure may reduce contact resistance because the substrate and the barrier metal layer may directly contact each other. The semiconductor layer, interposed between the substrate and the barrier metal layer, may be formed by chemical vapor deposition and/or epitaxial growth.

Example embodiments of the present invention provide a method of fabricating a semiconductor device, which forms a semiconductor layer with a desired thickness on a substrate exposed in a contact hole, and thus, a silicide layer, formed by the chemical combination of a barrier metal layer and the substrate, may not be undesirably diffused into the substrate. This method may include forming an interlayer insulating layer on a substrate where a first active region is defined and patterning the interlayer insulating layer to form a first contact hole exposing the first active region in a bar shape. The first contact hole may be formed after a semiconductor layer is formed on the first active region exposed in the first contact hole. A conformal barrier metal layer may be formed on the substrate where the first contact hole and the semiconductor layer have been formed. This method may further include forming an interlayer insulating layer on a substrate where a second active region is defined and patterning the interlayer insulating layer to form a second contact hole exposing the second active region in a dot shape. A conformal barrier metal layer may be formed on the substrate where the second contact hole has been formed. The semiconductor layer may be interposed between the barrier metal layer and the substrate of the first active region, and thus, the substrate may not be undesirably silicided. Since the substrate of the second active region directly contacts the barrier metal layer, the contact resistance thereof may be reduced even when the contact area therebetween is smaller.

### BRIEF DESCRIPTION OF THE DRAWINGS

Example embodiments of the present invention will be more clearly understood from the following detailed description taken in conjunction with the accompanying drawings. FIGS. 2A-7B represent non-limiting, example embodiments of the present invention as described herein.

FIGS. 1A-1D are diagrams illustrating a conventional semiconductor device;

FIGS. 2A-2D are diagrams illustrating a semiconductor device according to example embodiments of the present invention;

FIGS. 3A-7A are diagrams illustrating a method of fabricating a semiconductor device according to example embodiments of the present invention; and

FIGS. 3B-7B are diagrams illustrating a method of fabricating the semiconductor device according to example embodiments of the present invention.

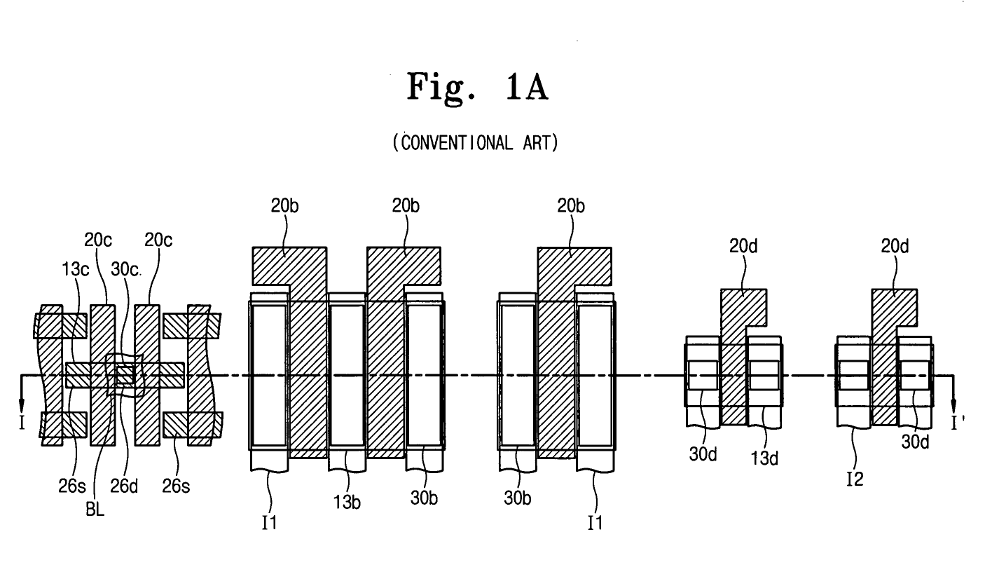

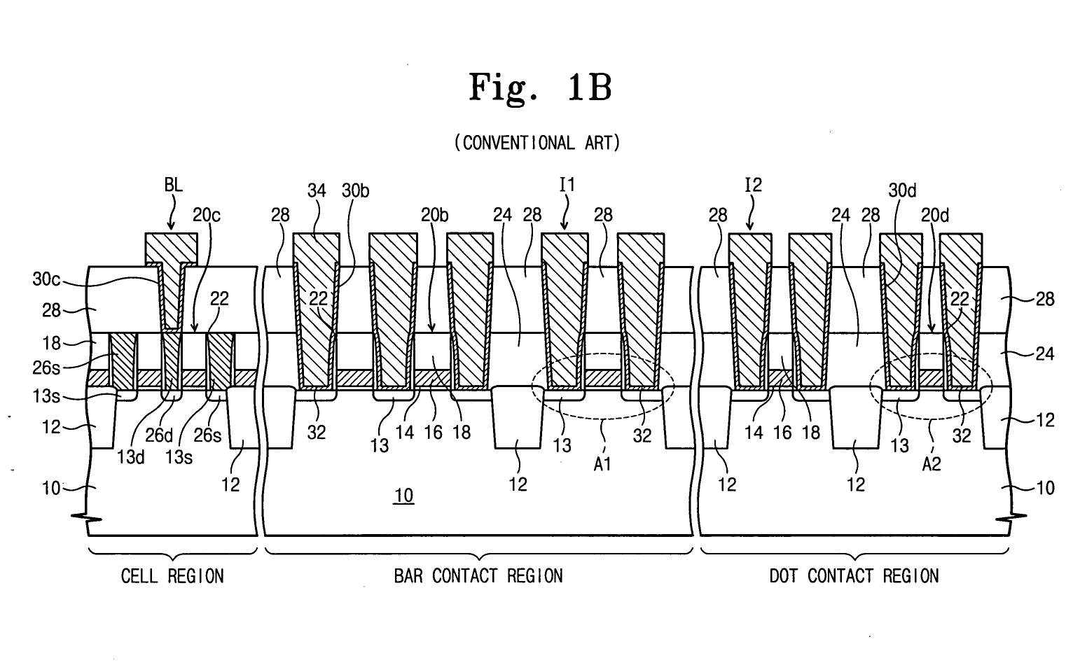

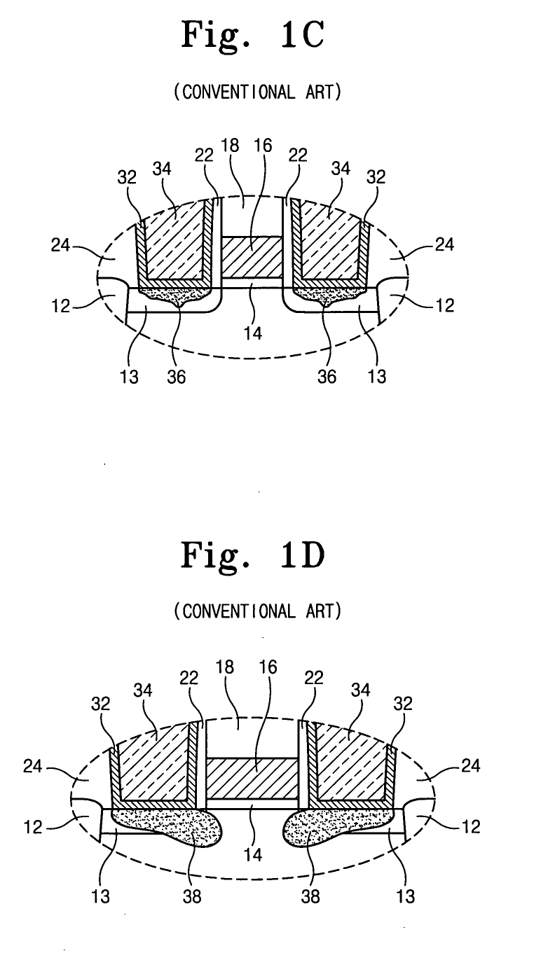

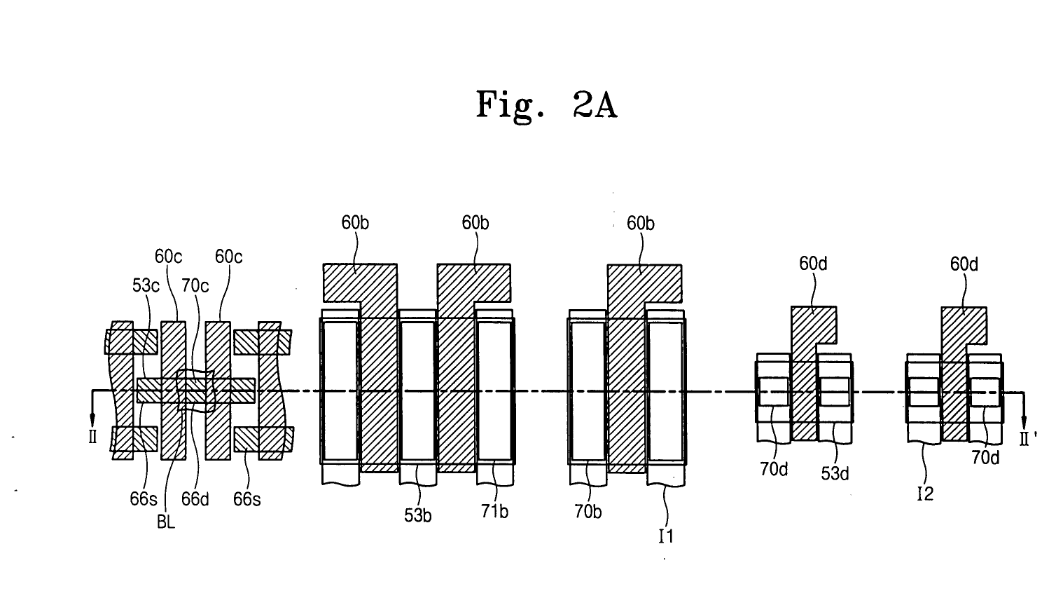

### DETAILED DESCRIPTION OF EXAMPLE EMBODIMENTS OF THE PRESENT INVENTION

Hereinafter, various example embodiments of the present invention will be explained in greater detail with reference to the accompanying drawings, in which some example embodiments of the present invention are shown. Example embodiments of the present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity. It will also be understood that when a layer is referred to as being “on” another layer or substrate, it can be directly on the other layer or substrate, or intervening layers may also be present. Like reference numerals in the drawings denote like elements, and thus their detailed description will be omitted for conciseness.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments of the present invention. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90° or at other orientations) and the spatially relative descriptors used herein interpreted accordingly.

The terminology used herein is for the purpose of describing particular embodiments only and is not intended to be limiting of the example embodiments of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of the present invention relate to a semiconductor device and a method of fabricating the same. Other example embodiments of the present invention relate to a semiconductor device having a metal silicide layer of a substrate and a barrier metal layer constituting a line layer and a method of fabricating the same.

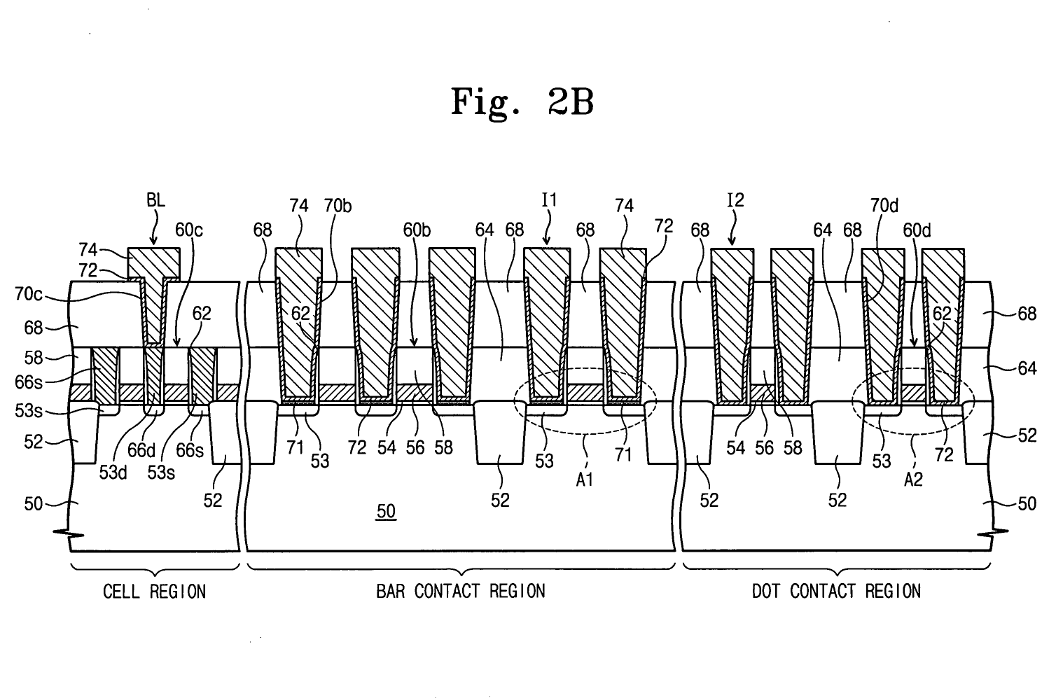

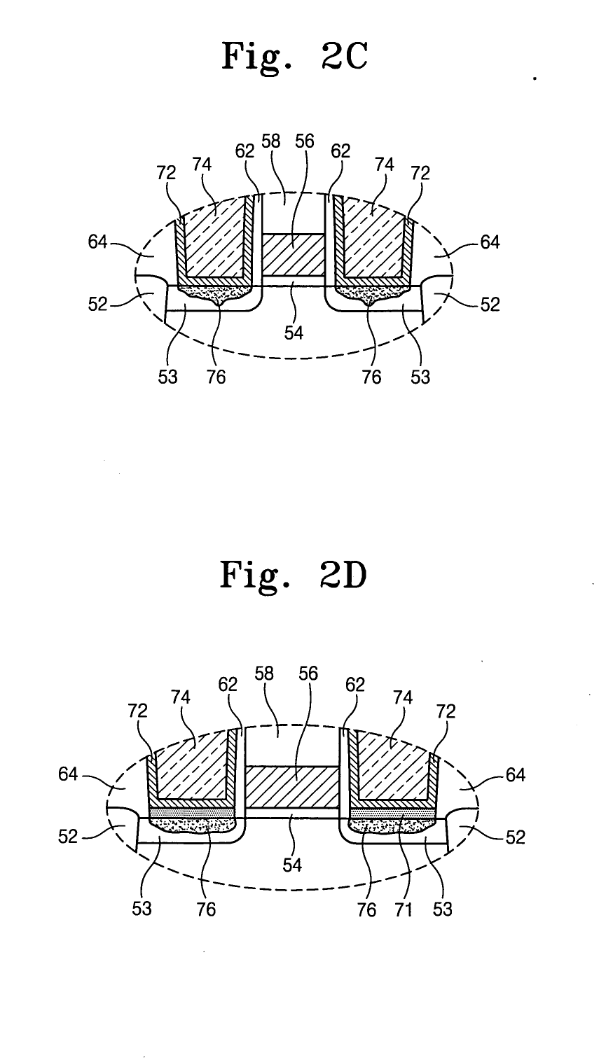

FIG. 2A is a diagram illustrating a DRAM device according to example embodiments of the present invention, and FIG. 2B is a diagram illustrating line II-II′ of FIG. 2A according to example embodiments of the present invention. Referring to FIGS. 2A and 2B, in the DRAM device, a cell region and a peripheral circuit region may be defined in a semiconductor substrate. The peripheral circuit region may be divided into a bar contact region where a contact area between a contact pattern and the substrate is larger and a dot contact region where the contact area is smaller. Taking into account space for a contact pattern, a transistor with a larger channel width may be disposed in the bar contact region and a transistor with a smaller channel width may be disposed in the dot contact region.

The DRAM device may include a device isolation layer 52 defining an active region in the semiconductor substrate 50. The DRAM device may also include a cell active region 53c, a first active region 53b, and a second active region 53d that are defined by the device isolation layer 52 in the cell region, the bar contact region, and the dot contact region, respectively. Gate patterns 60c, 60b and 60d are respectively formed on the cell active region 53c, the first active region 53b and the second active region 53d to cross over the active region. The gate pattern may include a gate insulating layer 54, a gate electrode 56, and a capping layer 58 that are stacked on the active region and a spacer pattern 62 formed on the sidewalls thereof. A source region 53s and a drain region 53d may be formed in the active region between the gate patterns of the cell region. A source pad 66s and a drain pad 66d, interposed between the gate patterns, may be formed on the source region 53s and the drain region 53d. In the bar contact region and the dot contact region, a source/drain region 53 may be formed in the active region at both sides of the gate patterns 60b and 60d.

An interlayer insulating layer may be formed on the entire surface of the semiconductor substrate 50. The source pad 66s and the drain pad 66d may penetrate a first interlayer insulating layer 64 formed on the substrate, and a second interlayer insulating layer 68 may be formed on the first insulating layer 64. A bit line BL may pass through the second interlayer insulating layer 68 and may be connected to the drain pad 66d. A first line I1 may pass through the second interlayer insulating layer 68 and may be connected to the first active region 53b. A second line 12 may pass through the first interlayer insulating layer 64 and may be connected to the second active region 53d. A bar-type contact hole 70b may be formed to pass through the first interlayer insulating layer 64 such that the first active region 53b may be exposed in a bar shape. A dot-type contact hole 70d may be formed to pass through the second interlayer insulating layer 68 such that the second active region 53d may be exposed in a dot shape. The first line I1 may be formed in the bar-type contact hole 70b and may be connected to the first active region 53b. The second line I2 may be formed in the dot-type contact hole 70d and may be connected to the second active region 53d.

Each of the lines may include a conformal barrier metal layer 72 formed on the bottom and the inner wall of the contact hole. Each of the lines may also include a conductive layer 74 filling the contact hole where the barrier metal layer 72 is formed and extending over the second interlayer insulating layer 68. The barrier metal layer 72 may be formed of a material (e.g., titanium, tantalum, nickel and/or cobalt), which may be chemically combined with a substrate or a semiconductor layer to form an ohmic contact layer. A semiconductor layer 71 may be formed on the active region in the bar-type contact hole 70b and may be interposed between the first line I1 and the first active region 53b. In the dot-type contact hole 70d, the barrier metal layer 72 may be formed to a desired thickness so as to reduce contact resistance between the substrate and the contact structure. The semiconductor layer 71 in the bar-type contact hole 70d may be formed to a relatively smaller thickness. For example, even when the semiconductor layer 71 is formed thinner than the barrier metal layer 72, the silicide layer may not spread out from the source region and/or the drain region or spread to the bottom of the gate electrode.

FIG. 2C is diagram illustrating a dot-type contact structure A2 formed in the dot-type contact hole 70d according to example embodiments of the present invention, and FIG. 2D is diagram illustrating a bar-type contact structure Al formed in the bar-type contact hole 70b according to example embodiments of the present invention. Referring to FIG. 2C, the substrate 50 may directly contact the barrier metal layer 72 and may be silicided to form the ohmic contact layer 76. According to example embodiments of the present invention, the dot-type contact structure A2 may have lower contact resistance.

Referring to FIG. 2D, in the bar-type contact structure A1 formed in the bar-type contact hole 70b, the semiconductor layer 71 may be interposed between the substrate 50 and the barrier metal layer 72 to provide a desired gap therebetween. The barrier metal layer 72 may be chemically combined with the semiconductor layer 71 directly contacting it, thereby silicidizing the semiconductor layer 71. The barrier metal layer 72 may further pass through the semiconductor layer 71 and may diffuse to the first active region 53b, thereby the barrier metal may be combined with the substrate 50 to silicidize the substrate. An ohmic contact layer 76 may be formed between the semiconductor layer 71 and the substrate 50. Even when the first active region 53b exposing the bar-type contact hole 70b is wider, the undesirable silicidation of the substrate 50 may be reduced or prevented.

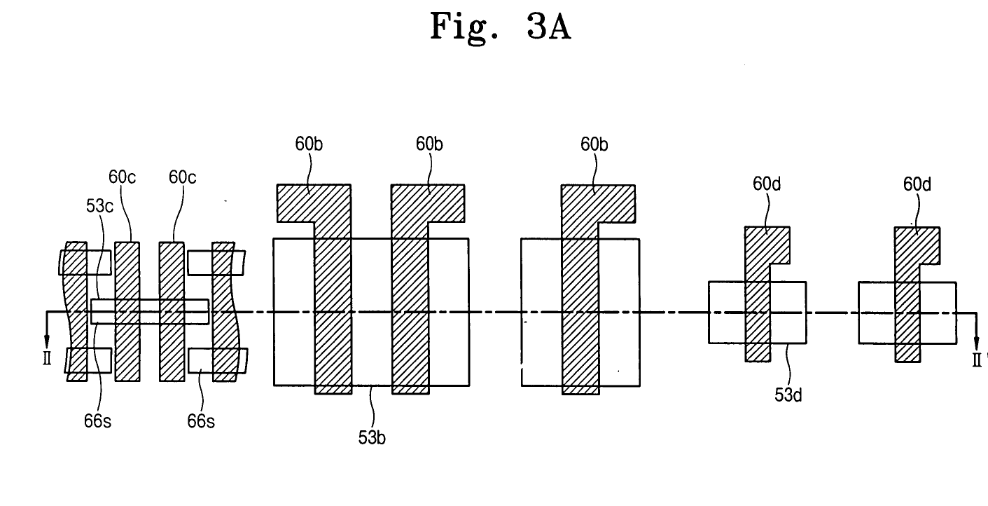

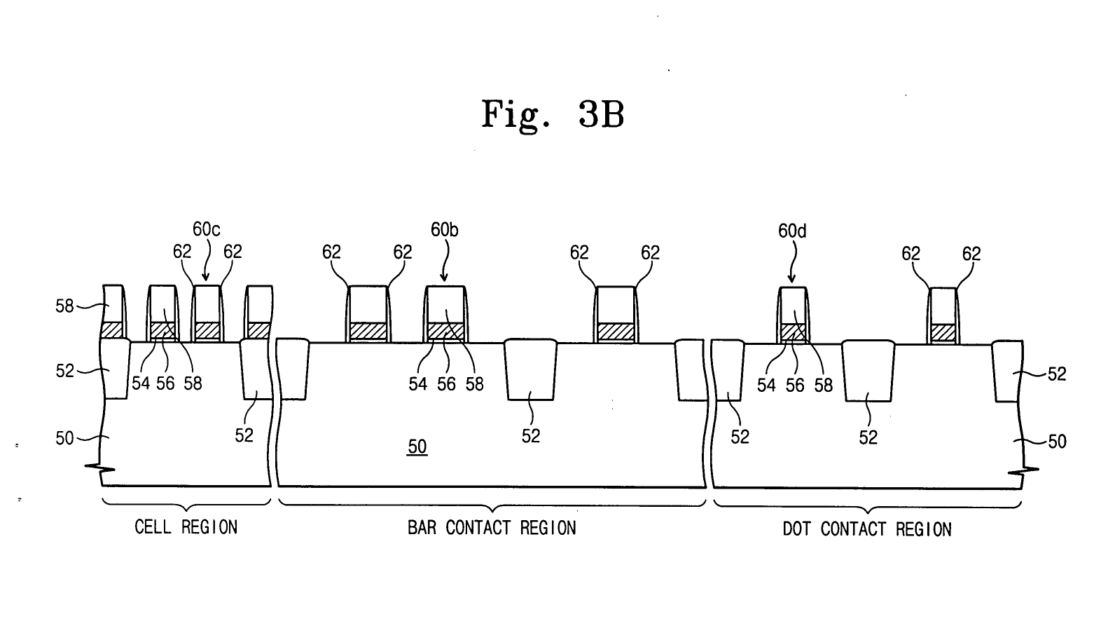

FIGS. 3A-7A are diagrams illustrating a method of fabricating a semiconductor device according to example embodiments of the present invention. FIGS. 3B-7B are diagrams illustrating line II-II′ of FIGS. 3A-7A according to example embodiments of the present invention. Referring to FIGS. 3A and 3B, a device isolation layer 52 may be formed in a semiconductor substrate 50 provided with a cell region, a bar contact region, and a dot contact region, thereby defining an active region. The device isolation layer 52 may define a cell active region 53c, a first active region 53b, and a second active region 53d in the cell region, the bar contact region, and the dot contact region, respectively. The first active region 53b, where a bar-type contact structure is to be formed, may be larger in area than the second active region 53d where a dot-type contact structure is to be formed.

A cell gate pattern 60c, serving as a wordline of a memory device, may be formed across the top portion of the cell active region 53c. A first gate pattern 60b and a second gate pattern 60d may be formed across the top portions of the first active region 53b and the second active region 53d, respectively. Each of the gate patterns 60b, 60c and 60d may include a gate insulating layer 54, a gate electrode 56, a capping layer 58, and a spacer pattern 62 formed on the sidewalls thereof. A cell source region 61s and a cell drain region 61d may be formed in the active region at both sides of the cell gate pattern 60c, respectively. Source/drain regions 61p may be formed in the active region at both sides of the first and second gate patterns 60b and 60d, respectively.

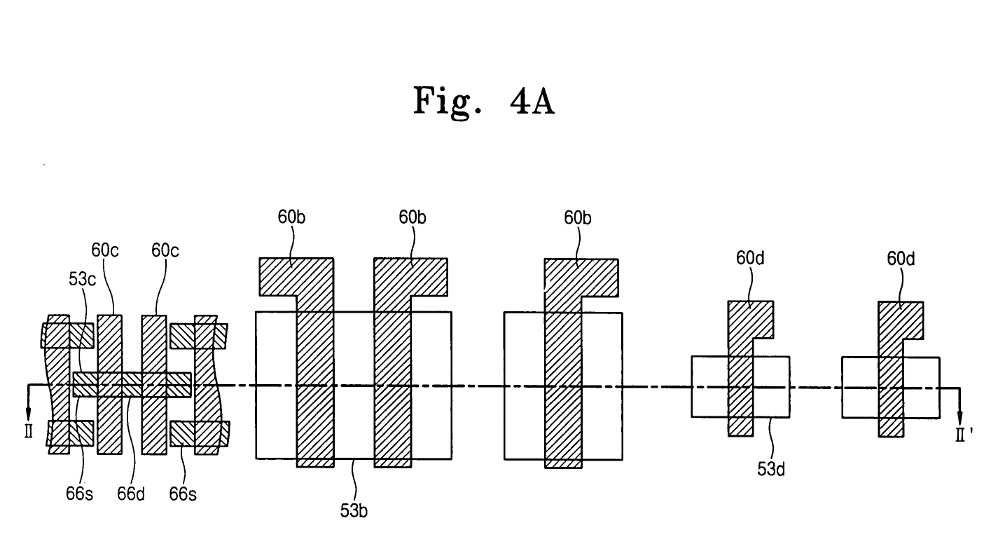

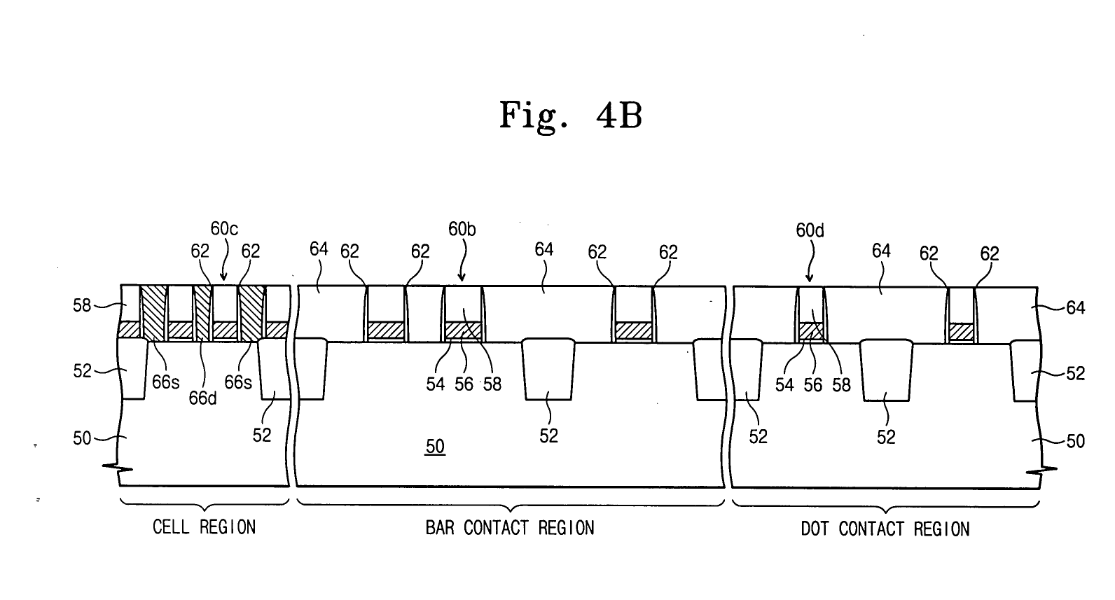

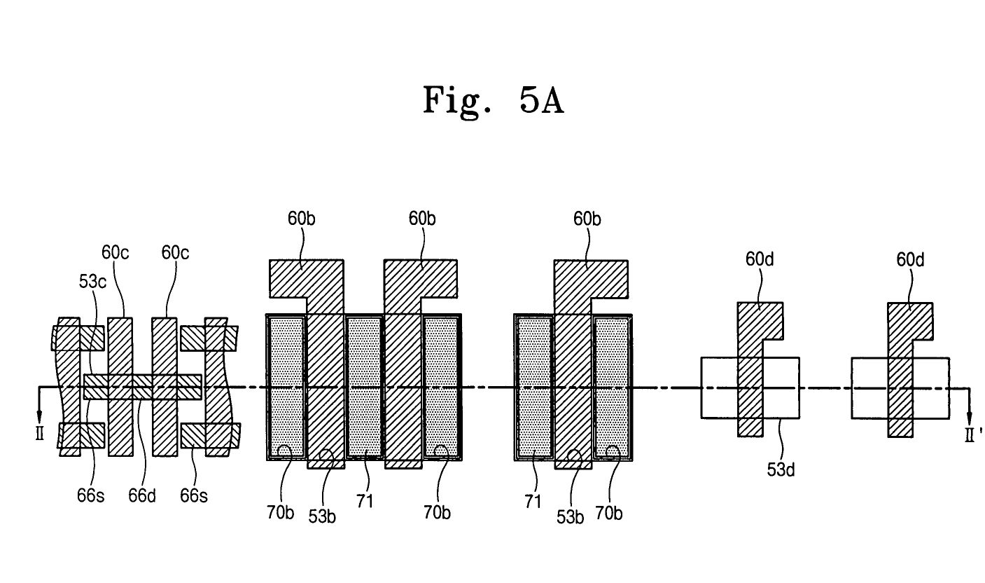

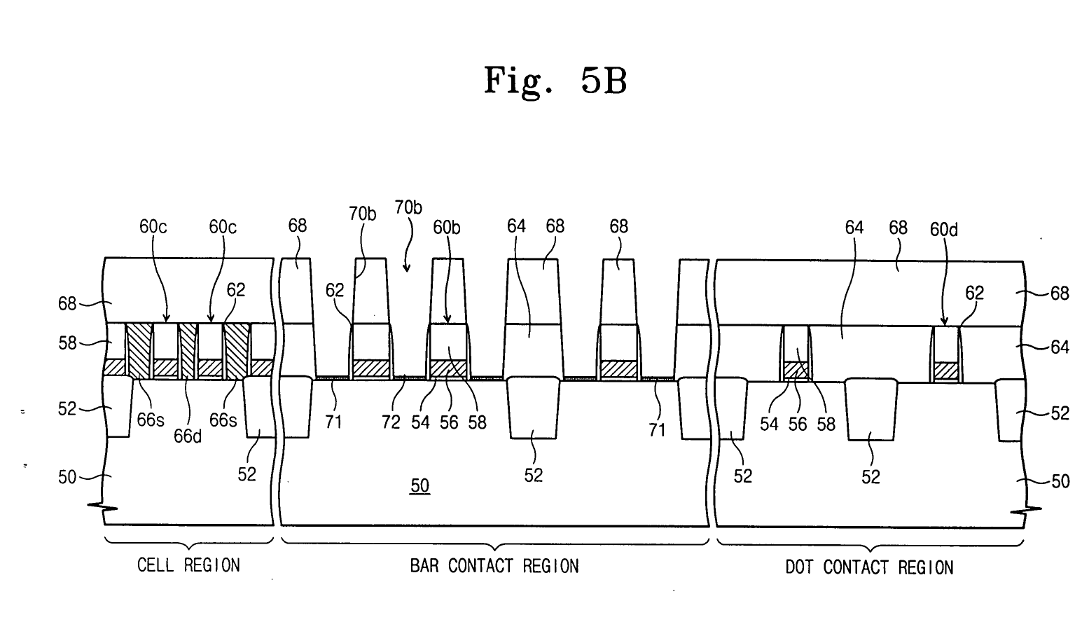

Referring to FIGS. 4A and 4B, a first interlayer insulating layer 64 may be formed on the entire surface of the semiconductor substrate. A source pad 66s and a drain pad 66d may be formed between the gate patterns 60c of the cell region. Referring to FIGS. 5A and 5B, a second interlayer insulating layer 68 may be formed on the first interlayer insulating layer 64. The second interlayer insulating layer 68 and the first interlayer insulating layer 68 may be sequentially patterned to form in the bar contact region a first contact hole 70b exposing the first active region 53b in a bar shape.

A process of isotropically etching portions of the first and second interlayer insulating layers 64 and 68 to expand the width of the first contact hole 70b may be further performed. Since the spacer pattern 62 and the capping layer 58 protect the gate electrode 56, the gate electrode 56 may not be exposed, and thus, the spacer pattern 62 may be aligned to expose the active region in a bar shape. A process of forming a spacer insulating layer at the sidewall of the first contact hole 70b may be further formed.

A semiconductor layer 72 may be formed in the first active region 53b exposed to the first contact hole 70b. The semiconductor layer 72 may be formed using epitaxial growth and/or chemical vapor deposition. With epitaxial growth, the semiconductor layer 72 may be formed only on the first active region 53b as illustrated. When chemical vapor deposition is used to form a semiconductor layer (e.g., a silicon layer), a conformal semiconductor layer may be formed in the first contact hole 70b. Since the semiconductor layer 72 has only to be interposed between the barrier metal layer and the substrate, it may be formed only on the exposed active region or may be formed in the contact hole. The first active region 53b, exposed to the first contact hole 70b, may be first doped with impurities before formation of the semiconductor layer 72, and then, the semiconductor layer 72 may be formed on the resulting impurity layer.

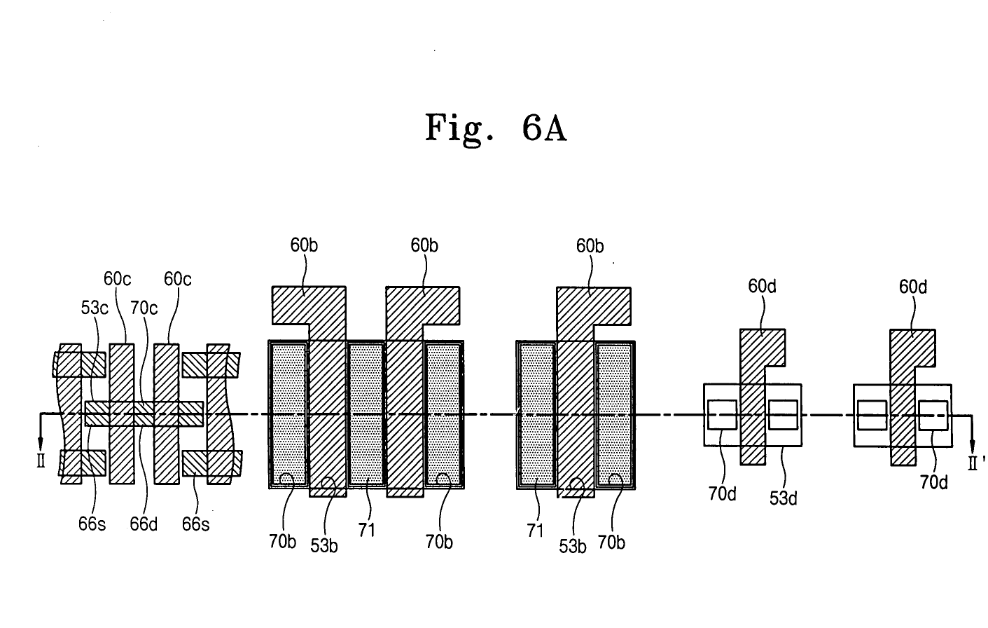

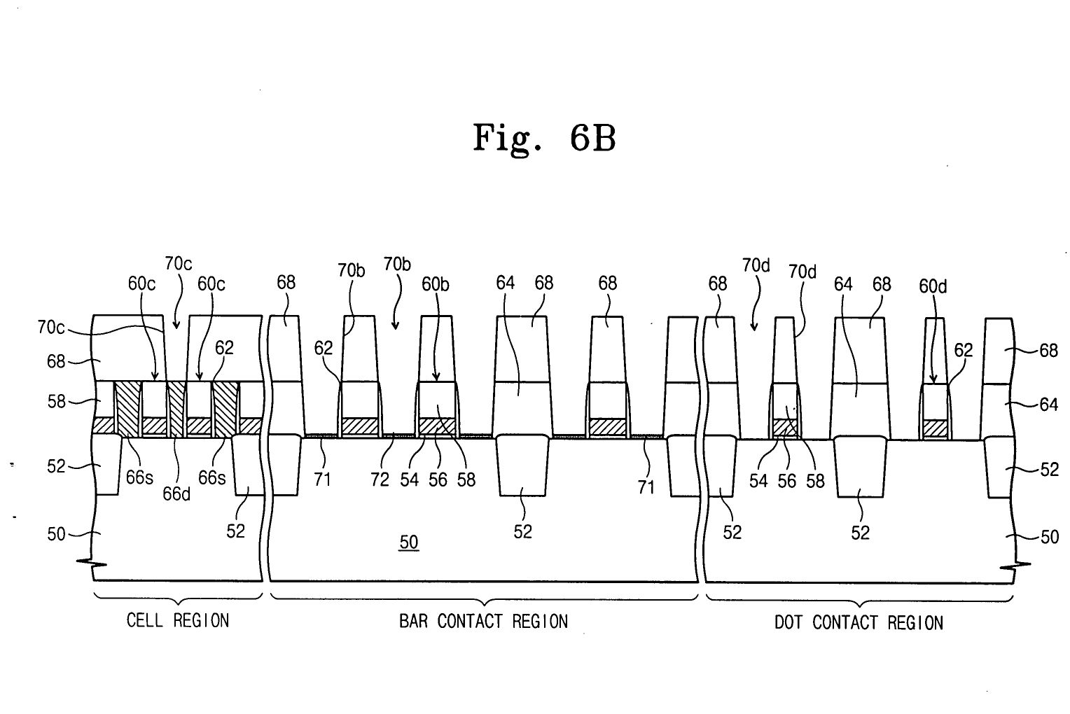

Referring to FIGS. 6A and 6B, the second interlayer insulating layer 68 of the cell region and the first interlayer insulating layer 64 of the dot contact region may be patterned to form a bit line contact hole 70c in the cell region and form a second contact hole 70d in the dot contact region. A lower layer may be exposed in a dot shape to the cell contact hole 70c and the second contact hole 70d. The drain pad 66d may be exposed to the cell contact hole 70c and the second active region 53d may be exposed to the second contact hole 70d. The cell contact hole 70c exposing the drain pad 66d, the first contact hole 70b exposing the first contact region 53c in a bar shape, and the second contact hole 70d exposing the second active region 53d in a dot shape may be formed in the semiconductor substrate.

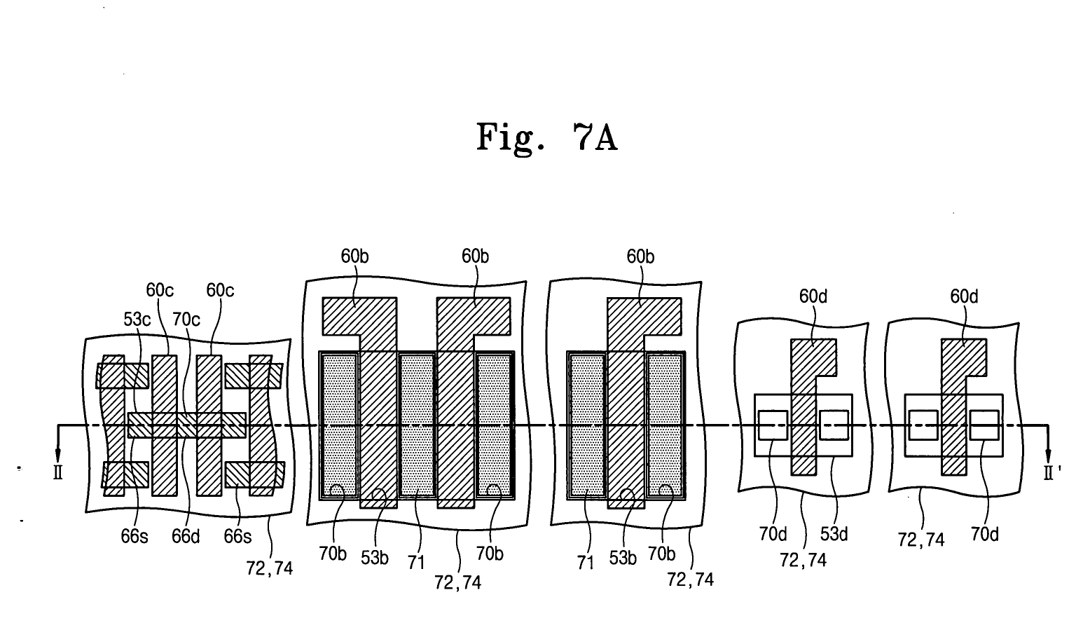

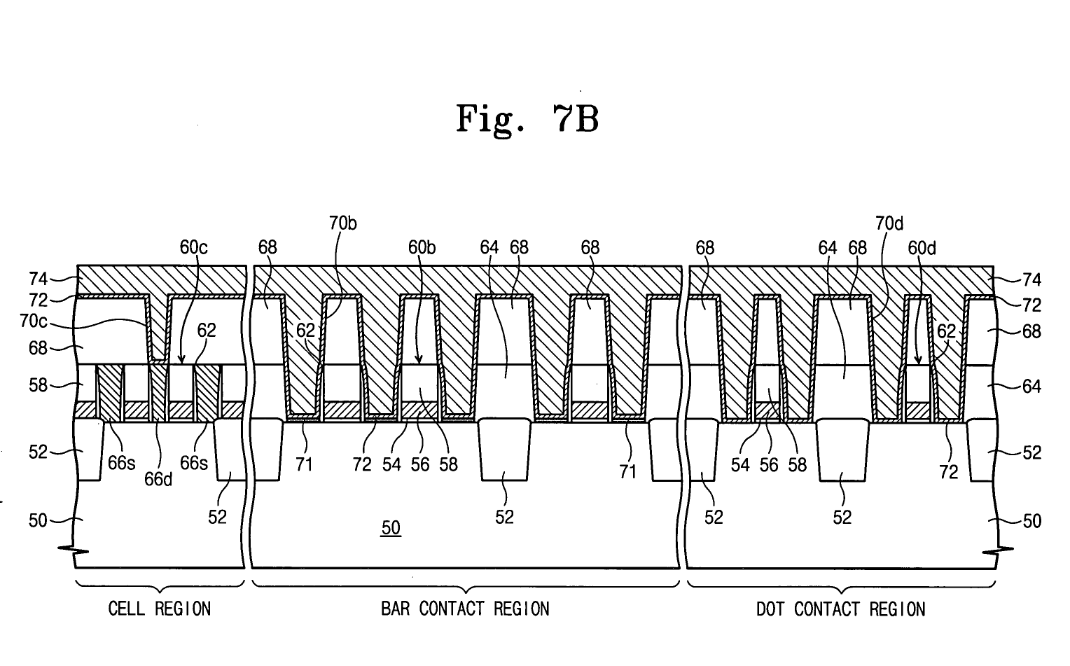

Referring to FIGS. 7A and 7B, a conformal barrier metal layer 72 may be formed on the entire surface of the substrate and a conductive layer 74 may be formed to fill the contact holes where the barrier metal layer 72 has been formed. The barrier metal layer 72 may be formed using a transition metal element (e.g., titanium, nickel and/or cobalt) that may be chemically combined with the substrate 50 or the semiconductor layer 71 to form an ohmic contact layer. The conductive layer 71 may be formed of a metal layer with improved capping characteristics and lower resistance (e.g., tungsten). The barrier metal layer 72 and the conductive layer 74 on the second interlayer insulating layer 68 may be patterned to the bit line BL and the line layers I1 and I2 illustrated in FIGS. 2A and 2B.

According to example embodiments of the present invention, the semiconductor device may include both the dot-type contact structure where a contact surface between the metal line and the active region has a dot shape and the bar-type contact structure where the contact surface has a bar shape. The silicide layer (e.g., the ohmic contact layer having the bar-type contact structure with the larger contact area between the barrier metal layer and the active region) may not be undesirably formed to generate a leakage current through the substrate, or diffused to the bottom of the gate electrode to electrically short the gate electrode and the metal line.

It will be apparent to those skilled in the art that various modifications and variations may be made in example embodiments of the present invention. It is intended that example embodiments of the present invention cover the modifications and variations of all of the example embodiments of the present invention provided they come within the scope of the appended claims and their equivalents.

What is claimed is:

1. A semiconductor device comprising:
a first active region formed on a semiconductor substrate;
an interlayer insulating layer formed on the semiconductor substrate, the first active region including a first contact hole exposing the first active region in a bar shape;
a semiconductor layer formed on the first active region in the first contact hole; and
a barrier metal layer formed on the interlayer insulating layer including the first and second contact holes, the semiconductor layer in the first contact hole.

2. The semiconductor device of claim 1, wherein the semiconductor layer is formed of polysilicon.

3. The semiconductor device of claim 1, wherein the semiconductor layer is an epitaxial layer.

4. The semiconductor device of claim 1, wherein the semiconductor layer is formed on an impurity diffusion layer of the first active region.

5. The semiconductor device of claim 4, wherein the semiconductor layer is chemically combined with the barrier metal layer to form a metal silicide layer.

6. The semiconductor device of claim 1, wherein the semiconductor layer is smaller in thickness than the barrier metal layer.

7. The semiconductor device of claim 1, further comprising:
a conductive layer formed on the barrier metal layer to fill the first contact hole.

8. The semiconductor device of claim 1, further comprising:
a second active region formed on the semiconductor substrate;
the interlayer insulating layer formed on the semiconductor substrate, the second active region including a second contact hole exposing the second active region in a dot shape;
the barrier metal layer formed on the interlayer insulating layer including the second contact hole and the second active region in the second contact hole; and
a conductive layer formed on the barrier metal layer to fill the second contact hole.

9. A method of fabricating a semiconductor device, the method comprising:
forming an interlayer insulating layer on a substrate where a first active region is defined;
patterning the interlayer insulating layer to form a first contact hole exposing the first active region in a bar shape;
forming a semiconductor layer on the first active region exposed in the first contact hole; and
forming a conformal barrier metal layer on the substrate where the first contact hole and the semiconductor layer have been formed.

10. The method of claim 9, wherein the semiconductor layer is a semiconductor epitaxial layer that is epitaxially grown on the first active region exposed in the first contact hole.

11. The method of claim 9, wherein the semiconductor layer is a polysilicon layer formed on the first active region in the first contact hole.

12. The method of claim 9, wherein the semiconductor layer is formed thinner than the barrier metal layer.

13. The method of claim 9, further comprising:
before forming the semiconductor layer, doping the first active region exposed in the first contact hole with impurities.

14. The method of claim 13, wherein the semiconductor layer is formed thinner than the barrier metal layer.

15. The method of claim 9, further comprising:
forming on the interlayer insulating layer a line electrically connected to the first active region.

16. The method of claim 9, further comprising:
forming the interlayer insulating layer on the substrate where a second active region is defined;
patterning the interlayer insulating layer to form a second contact hole exposing the second active region in a dot shape;
forming the conformal barrier metal layer on the substrate where the second contact hole has been formed; and
forming on the interlayer insulating layer a line electrically connected to the second active region.
